(19) United States
(12) Patent Application Publication
(10) Pub. No.: US 2026/0360043 A1
(43) Pub. Date: Nov. 12, 2026

(54) METHOD AND DEVICE FOR GENERATING CONTENT TO FACILITATE MEDICAL IMAGING

(71) Applicants: VATECH Co., Ltd., Gyeonggi-do (KR); VATECH EWOO Holdings Co., Ltd., Gyeonggi-do (KR)

(72) Inventors: Chang Joon RO, Gyeonggi-do (KR); Sung II Choi, Gyeonggi-do (KR); Jun Sung Hwang, Gyeonggi-do (KR); Ji Woong Park, Gyeonggi-do (KR); Young Joo Lee, Gyeonggi-do (KR)

(73) Assignees: VATECH Co., Ltd., Gyeonggi-do (KR); VATECH EWOO Holdings Co., Ltd., Gyeonggi-do (KR)

(21) Appl. No.: 19/656,967

(22) Filed: Apr. 23, 2026

(30) Foreign Application Priority Data
May 8, 2025 (KR) 10-2025-0059769

(51) Int. Cl. G06T 11/60; G06V 10/70; G06V 20/40; G06V 20/50; G06V 40/16; G10L 13/027

(52) U.S. Cl. CPC G06T 11/60; G06V 10/70; G06V 20/40; G06V 20/50; G06V 40/16; G10L 13/027; G06T 2210/41; G06V 2201/03

(57) ABSTRACT

Proposed is a method of generating voice content to facilitate medical imaging, the method being performed by at least one processor. The method includes receiving a voice sample of a first user, generating voice content that mimics the first user's voice on the basis of the voice sample, by using a first machine learning model, and outputting the voice content during acquisition of a medical video of a second user.

### CROSS REFERENCE TO RELATED APPLICATION

The present application claims priority to Korean Patent Application No. 10-2025-0059769, filed 8 May 2025, the entire contents of which is incorporated herein for all purposes by this reference.

### BACKGROUND OF THE INVENTION

### Field of the Invention

The present disclosure relates to a method and a device for generating content to facilitate medical imaging.

### Description of the Related Art

In a medical imaging process, a person with limited mental or physical stability, including a child or a person with developmental disabilities, often feels severe tension and anxiety regarding a closed environment of an imaging room or operating noise of equipment. As a result, a person with limited mental or physical stability may not properly understand guidance announcements required for medical imaging, or may exhibit an unexpected behavior such as a sudden movement even if the announcements are understood.

Such unexpected behavior may reduce the quality of a medical video and may cause safety problems such as equipment malfunction or patient injury. A person with limited mental or physical stability has a deep attachment relationship with a guardian, and thus, accompaniment of the guardian during medical imaging may be most effective for easing the tension of the person with limited mental or physical stability. However, since only medical staff are generally allowed to enter an imaging room, it is difficult to apply such a method.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure provides a method and a device (system) for generating content to facilitate medical imaging in order to solve the problems as described above.

According to an embodiment of the present disclosure, there is provided a method of generating content to facilitate medical imaging, the method including: receiving a voice sample or a video sample of a first user or both; generating, by using a machine learning model, voice content or video content or both mimicking the first user's voice or face or both on the basis of the voice sample or the video sample or both; and outputting the content during acquisition of a medical video of a second user.

According to an embodiment of the present disclosure, there is provided a device for generating content to facilitate medical imaging, the device including: a communication module, a memory, and at least one processor connected to the memory, and configured to execute at least one computer-readable program included in the memory, wherein the at least one program includes instructions for: receiving a voice sample or a video sample of a first user or both; generating, by using a machine learning model, voice content or video content or both mimicking the first user's voice or face or both on the basis of the voice sample or the video sample or both; and outputting the voice content or the video content or both during acquisition of a medical video of a second user.

According to an embodiment of the present disclosure, the physical and mental state of a subject can be stabilized during medical imaging by generating and outputting voice or a video of a person with whom the subject has an attachment relationship, or both of the voice and the video. Accordingly, risks, such as an injury to a subject, during medical imaging can be reduced, and a high-quality medical video can be acquired.

According to an embodiment of the present disclosure, voice or video content appropriate for a situation can be generated by analyzing an emotional state of a subject, on the basis of a facial video of the subject. Accordingly, the physical and mental state of the subject can be stabilized.

Effects that may be obtained from the present disclosure will not be limited to only the above described effects. In addition, other effects which are not described herein will be clearly understood by those skilled in the art to which the present disclosure pertains (hereinafter, referred to as a “person skilled in the art”) from the description of the claims.

### BRIEF DESCRIPTION OF THE DRAWINGS

Embodiments of the present disclosure will be described with reference to the accompanying drawings described below, wherein similar reference numerals denote similar elements, but are not limited thereto, in which:

FIG. 1 is a diagram illustrating an example of a method of generating voice content to facilitate medical imaging according to an embodiment of the present disclosure;

FIG. 2 is a schematic diagram illustrating a configuration in which an information processing system is connected to be capable of communicating with a plurality of user terminals, in order to generate voice content to facilitate medical imaging according to an embodiment of the present disclosure;

FIG. 3 is a block diagram illustrating internal configurations of a user terminal and an information processing system according to an embodiment of the present disclosure;

FIG. 4 is a diagram illustrating an example of a method of generating voice content according to an embodiment of the present disclosure;

FIG. 5 is a diagram illustrating an example of a method of generating voice content according to an embodiment of the present disclosure;

FIG. 6 is a diagram illustrating an example of a method of generating video content according to an embodiment of the present disclosure;

FIG. 7 is a diagram illustrating an example in which video content is output on a display according to an embodiment of the present disclosure; and

FIG. 8 is a flowchart illustrating an example of a method of generating voice content according to an embodiment of the present disclosure.

### DETAILED DESCRIPTION OF THE INVENTION

According to an embodiment of the present disclosure, a “module” or “part” may be implemented as a processor and a memory. The “processor” should be interpreted broadly to encompass a general-purpose processor, a central processing unit (CPU), a microprocessor, a digital signal processor (DSP), a controller, a microcontroller, and a state machine. In some environments, the “processor” may also refer to an application-specific integrated circuit (ASIC), a programmable logic device (PLD), and a field-programmable gate array (FPGA). The “processor” may also refer to a combination for processing devices, for example, a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may also refer to various types of processor-readable media such as a random-access memory (RAM), a read-only memory (ROM), a non-volatile random-access memory (NVRAM), a programmable read-only memory (PROM), an erasable programmable read-only memory (EPROM), an electrically erasable PROM (EEPROM), a flash memory, a magnetic or optical data storage device, and registers. If a processor can read information from a memory and/or write information to the memory, the memory is referred to as being in electronic communication with the processor. A memory integrated into a processor is in electronic communication with the processor.

In the present disclosure, a “system” may include a server device or a cloud device or both, but the present disclosure is not limited thereto. For example, the system may include one or more server devices. As another example, the system may include one or more cloud devices. As still another example, the system may include both a server device and a cloud device operated in conjunction with each other.

In the present disclosure, a “display” may refer to any display device associated with a computing device, for example, any display device capable of displaying any information/data controlled or provided by the computing device.

In the present disclosure, “each of a plurality of As” or “each of the plurality of As” may refer to each of all elements included in the plurality of As, or may refer to each of some elements included in the plurality of As.

In the present disclosure, a “machine learning model” may include any model used for inferring an answer to a given input. According to an embodiment, the machine learning model may include an artificial neural network model including an input layer, a plurality of hidden layers, and an output layer. Herein, each layer may include a plurality of nodes. In the present disclosure, each of a plurality of machine learning models is described as a separate machine learning model, but the present disclosure is not limited thereto. Some or all of the plurality of machine learning models may be implemented as a single machine learning model. In addition, one machine learning model may include a plurality of machine learning models. In the present disclosure, the terms “machine learning model” and “artificial neural network model” may be used interchangeably to represent the same or similar models.

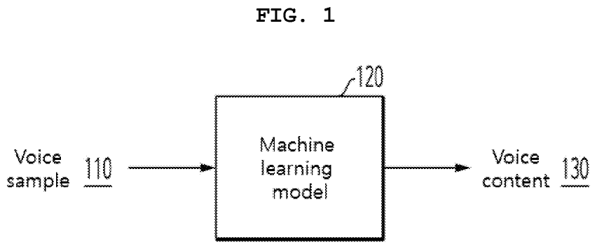

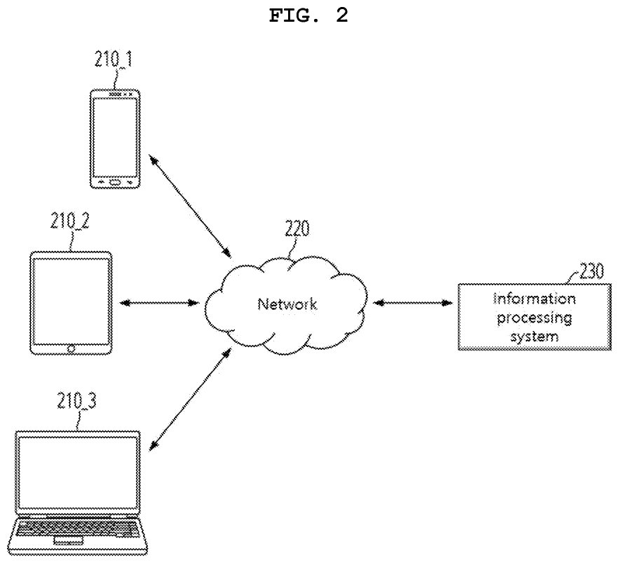

FIG. 1 is a diagram illustrating an example of a method of generating voice content to facilitate medical imaging according to an embodiment of the present disclosure. In an embodiment, a processor (for example, at least one processor of an information processing system to be described later in FIG. 2) may receive a voice sample 110 of a first user. Herein, the first user may be a guardian who has an attachment relationship with a second user (for example, a person with limited mental or physical stability, such as a child or a person with developmental disabilities), who is a subject of medical imaging using a medical device. In addition, the voice sample 110 may include at least one selected from the group of a sentence including various consonants and vowels spoken by the first user, a sentence including various intonations and tones, and a medical imaging guidance announcement. Such a voice sample 110 may be received from a terminal of a hospital equipped with the medical device or from the first user's terminal.

In an embodiment, the processor may use a machine learning model 120 to generate voice content 130 that mimics the first user's voice on the basis of the voice sample 110. Herein, the machine learning model 120 may be trained to receive the voice sample 110 as input and to output the voice content 130 that reflects the first user's vocal characteristic. In addition, the voice content 130 may include at least one selected from the group of a countdown for acquiring a medical video, an explanation of acquiring a medical video, an everyday conversation, and a song. For example, the voice content 130 may include a countdown for acquiring a medical video and a medical imaging guidance announcement mimicking the first user's voice, such as “Just hold still for 10 seconds and the capturing will be over. 10, 9, 8, . . . ”, a conversation delivered to the second user in the first user's voice, or a song sung in the first user's voice, but the present disclosure is not limited thereto. Such voice content 130 may be transmitted to the medical device, to a terminal of the hospital equipped with the medical device, or to the first user's terminal.

In an embodiment, the processor may output the voice content 130 during medical imaging. Specifically, the processor may transmit the voice content 130 to the medical device used in medical imaging. In this case, the voice content 130 may be output from the medical device (or a speaker provided in the medical device) during medical imaging. It has been described that the information processing system is separated from the medical device with reference to FIG. 1, but the present disclosure is not limited thereto. The processor of the medical device may generate and output the voice content 130.

In an embodiment, the machine learning model 120 may generate voice content 130 on the basis of a voice sample of an animated character that the second user prefers. Herein, the voice content 130 may include at least one selected from the group of a countdown for acquiring a medical video, an explanation of acquiring a medical video, an everyday conversation, and a song, mimicking the animated character's voice. In this case, the machine learning model 120 may be trained to receive the animated character's voice sample as input and to output the voice content 130 that reflects the animated character's vocal characteristic.

With this configuration, the physical and mental state of a subject may be stabilized during medical imaging by generating and outputting the voice of a person with whom the subject has an attachment relationship. Accordingly, risks, such as an injury to a subject, during medical imaging may be reduced, and a high-quality medical video may be acquired.

FIG. 2 is a schematic diagram illustrating a configuration in which an information processing system 230 is connected to be capable of communicating with a plurality of user terminals 210_1, 210_2, and 210_3, in order to generate voice content to facilitate medical imaging according to an embodiment of the present disclosure. As illustrated, the plurality of user terminals 210_1, 210_2, and 210_3 may be connected over a network 220 to the information processing system 230 that may provide a voice content generation service. Herein, the plurality of user terminals 210_1, 210_2, and 210_3 may include a terminal or the medical device of a user who is provided with the voice content generation service.

In an embodiment, the information processing system 230 may include one or more server devices and/or databases or one or more distributed computing devices and/or distributed databases based on a cloud computing service, capable of storing, providing, and executing a computer-executable program (for example, a downloadable application) and data associated with providing the voice content generation service. The information processing system 230 may include the medical device or a server device in a hospital equipped with the medical device.

The voice content generation service provided by the information processing system 230 may be provided to a user through a voice content generation application, a web browser, or a web browser extension program installed in each of the plurality of user terminals 210_1, 210_2, and 210_3. For example, the information processing system 230 may provide information corresponding to a voice content generation request received from the user terminals 210_1, 210_2, and 210_3 through the voice content generation application, or may perform a processing corresponding thereto.

The plurality of user terminals 210_1, 210_2, and 210_3 may communicate with the information processing system 230 over the network 220. The network 220 may be configured to enable communication between the plurality of user terminals 210_1, 210_2, and 210_3 and the information processing system 230. The network 220 may be configured as a wired network, such as Ethernet, a wired home network (power-line communication), a telephone line communication device, or RS-serial communication; a wireless network, such as a mobile communication network, a wireless LAN (WLAN), Wi-Fi, Bluetooth, or ZigBee; or a combination thereof, depending on an installation environment. The communication method is not limited, and may include communication methods utilizing communication networks (for example, a mobile communication network, the wired Internet, the wireless Internet, a broadcasting network, and a satellite network) that the network 220 may include, as well as short-range wireless communication between the user terminals 210_1, 210_2, and 210_3.

FIG. 2 illustrates that the mobile phone terminal 210_1, the tablet terminal 210_2, and the PC terminal 210_3 are examples of user terminals, but the present disclosure is not limited thereto. The user terminals 210_1, 210_2, and 210_3 may be any computing devices capable of wired and/or wireless communication and having the voice content generation application or the web browser installed to be executed. For example, user terminals may include an AI speaker, a smartphone, a mobile phone, a navigation device, a computer, a laptop computer, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, and a set-top box. In addition, FIG. 2 illustrates that three user terminals 210_1, 210_2, and 210_3 communicate with the information processing system 230 over the network 220, but the present disclosure is not limited thereto. A different number of user terminals may be configured to communicate with the information processing system 230 over the network 220.

FIG. 2 illustrates an exemplary configuration in which a user request (for example, a voice content generation request) is transferred to the information processing system 230 through the user terminals 210_1, 210_2, and 210_3, but the present disclosure is not limited thereto. The user request may be provided to the information processing system 230 through an input device associated with the information processing system 230 without passing through the user terminals 210_1, 210_2, and 210_3, and a result (for example, voice content) of processing the user request may be provided to the user through an output device (for example, a speaker or a display) associated with the information processing system 230.

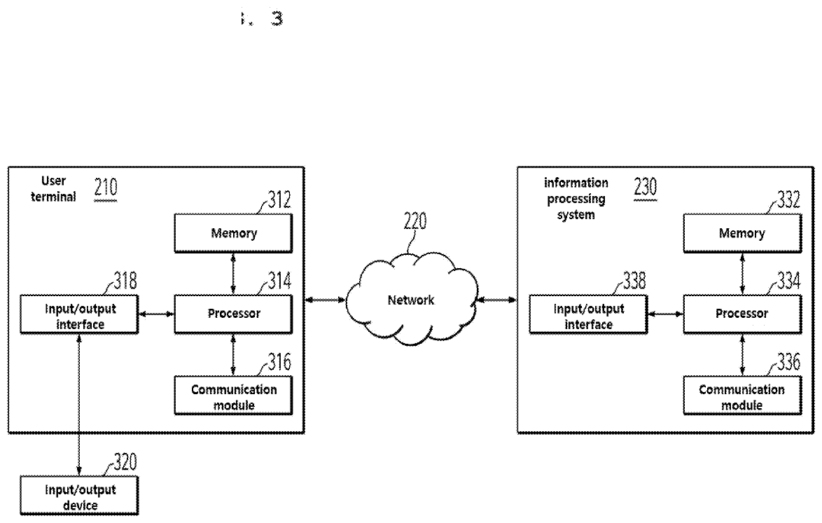

FIG. 3 is a block diagram illustrating internal configurations of a user terminal 210 and an information processing system 230 according to an embodiment of the present disclosure. The user terminal 210 may refer to any computing device capable of executing an application or a web browser and performing wired/wireless communication. Examples of the user terminal may include the mobile phone terminal 210_1, the tablet terminal 210_2, and the PC terminal 210_3 shown in FIG. 2. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to use the respective communication modules 316 and 336 to communicate information and/or data over the network 220. In addition, the input/output device 320 may be configured to, through the input/output interface 318, input information and/or data to the user terminal 210 or output information and/or data generated from the user terminal 210.

The memories 312 and 332 may include any non-transitory computer-readable recording medium. According to an embodiment, the memories 312 and 332 may include a permanent mass storage device, such as a read-only memory (ROM), a disk drive, a solid-state drive (SSD), or a flash memory. As another example, the permanent mass storage device, such as a ROM, an SSD, a flash memory, or a disk drive, may be included in the user terminal 210 or the information processing system 230 as a separate permanent storage device distinguished from a memory. In addition, an operating system and at least one program code may be stored in the memories 312 and 332.

These software elements may be loaded from a computer-readable recording medium separate from the memories 312 and 332. Such a separate computer-readable recording medium may include a recording medium directly connectable to the user terminal 210 and the information processing system 230, and may include a computer-readable recording medium, such as a floppy drive, a disk, a tape, a DVD/CD-ROM drive, or a memory card. As another example, the software elements may be loaded into the memories 312 and 332 through the communication modules 316 and 336 rather than a computer-readable recording medium. For example, at least one program may be loaded into the memories 312 and 332 on the basis of a computer program that is installed using files provided by developers or a file distribution system, which distributes application installation files, over the network 220.

The processors 314 and 334 may be configured to process instructions of a computer program by performing basic arithmetic, logic, and input/output operations. The instructions may be provided to the processors 314 and 334 by the memories 312 and 332 or the communication modules 316 and 336. For example, the processors 314 and 334 may be configured to execute received instructions according to program code stored in recording devices such as the memories 312 and 332.

The communication modules 316 and 336 may provide a configuration or a function for communication between the user terminal 210 and the information processing system 230 over the network 220, and may provide a configuration or a function for communication with the user terminal 210 and/or the information processing system 230 and another user terminal or another system (for example, a separate cloud system). For example, a request or data (for example, a voice content generation request) generated by the processor 314 of the user terminal 210 according to program code stored in a recording device, such as the memory 312, may be transferred to the information processing system 230 over the network 220 under the control of the communication module 316. Conversely, control signals or instructions provided under the control of the processor 334 of the information processing system 230 may be received by the user terminal 210 through the communication module 316 of the user terminal 210 via the communication module 336 and the network 220.

The input/output interface 318 may be a means for interfacing with the input/output device 320. As an example, the input device may include a device such as a camera including an audio sensor and/or an image sensor, a keyboard, a microphone, or a mouse, and the output device may include a device such as a display, a speaker, or a haptic feedback device. As another example, the input/output interface 318 may be a means for interfacing with a device, such as a touch screen, in which configurations or functions for performing input and output are integrated into one. For example, when the processor 314 of the user terminal 210 processes instructions of a computer program loaded into the memory 312, a service screen configured using information and/or data provided by the information processing system 230 or another user terminal may be displayed on a display through the input/output interface 318. FIG. 3 illustrates that the input/output device 320 is not included in the user terminal 210, but the present disclosure is not limited thereto. The input/output device may be configured as a single device with the user terminal 210. In addition, the input/output interface 338 of the information processing system 230 may be a means for interfacing with a device (not shown) for input or output that may be connected to the information processing system 230 or included in the information processing system 230. FIG. 3 illustrates that the input/output interfaces 318 and 338 are elements configured separately from the processors 314 and 334, but the present disclosure is not limited thereto. The input/output interfaces 318 and 338 may be configured to be included in the processors 314 and 334.

The user terminal 210 and the information processing system 230 may include more elements than elements shown in FIG. 3. In an embodiment, the user terminal 210 may be implemented to include at least a portion of the input/output device 320 described above. In addition, the user terminal 210 may further include other elements such as a transceiver, a Global Positioning System (GPS) module, a camera, various sensors, and a database. For example, when the user terminal 210 is a smartphone, the user terminal may include elements generally included in a smartphone. For example, various elements such as an acceleration sensor, a gyro sensor, a microphone module, a camera module, various physical buttons, buttons using a touch panel, input/output port, and a vibrator for vibration may be further included in the user terminal 210.

While a program or an application for a voice content generation service is operated, the processor 314 may receive text, an image, a video, voice, and/or a motion input or selected through an input device, such as a touch screen, a keyboard, a camera including an audio sensor and/or an image sensor, a microphone, connected to the input/output interface 318, and may store the received text, image, video, voice, and/or motion in the memory 312 or may provide the same to the information processing system 230 through the communication module 316 and the network 220.

The processor 314 of the user terminal 210 may be configured to manage, process and/or store information and/or data received from the input/output device 320, another user terminal, the information processing system 230, and/or a plurality of external systems. The information and/or data processed by the processor 314 may be provided to the information processing system 230 through the communication module 316 and the network 220. The processor 314 of the user terminal 210 may transmit the information and/or data to the input/output device 320 through the input/output interface 318 for output. For example, the processor 314 may output or display the received information and/or data on a screen associated with the user terminal 210.

The processor 334 of the information processing system 230 may be configured to manage, process and/or store information and/or data received from the plurality of user terminals 210 and/or the plurality of external systems. The information and/or data processed by the processor 334 may be provided to the user terminal 210 through the communication module 336 and the network 220.

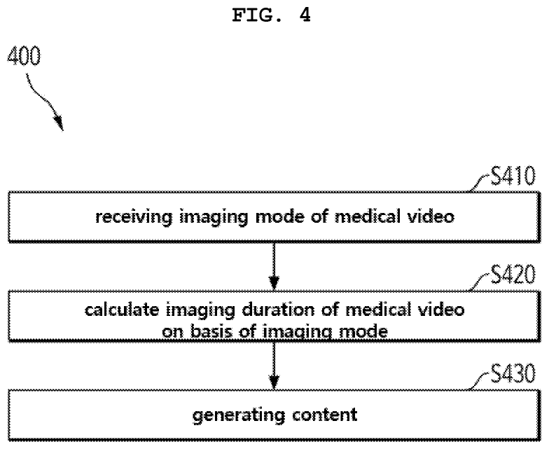

FIG. 4 is a diagram illustrating an example of a method 400 of generating voice content according to an embodiment of the present disclosure. In an embodiment, the method 400 of generating voice content may be performed by at least one processor (334 in FIG. 3, for example). The method 400 of generating voice content may be initiated by the processor receiving the voice sample or the video sample of the first user or both. In addition, the processor may receive an imaging mode of a medical video in step S410. Herein, the first user may be a guardian of the second user, who is a subject of medical imaging.

Afterward, the processor may calculate an imaging duration of the medical video on the basis of the imaging mode in step S420. Herein, the imaging mode may include an oral imaging mode and a facial imaging mode for the second user. In addition, the imaging duration of the medical video may be predetermined according to the imaging mode. For example, the oral imaging mode may require a shorter imaging duration than the facial imaging mode. Alternatively, the processor may calculate the imaging duration of the medical video on the basis of the imaging mode and information (for example, the second user's age, sex, height, weight, and facial size) associated with the second user. For example, a younger age of the second user may require a longer imaging duration.

Afterward, the processor may generate voice content or video content or both on the basis of the calculated imaging duration in step S430. In this case, the processor may generate voice content or video content or both by using a machine learning model. Herein, the machine learning model may be trained to receive an imaging duration and a voice sample or a video sample or both as input and to output voice content or video content or both reflecting a vocal characteristic or a facial characteristic of the first user or both.

In an embodiment, content may include a countdown for acquiring a medical video mimicking the first user's voice. In this case, the countdown for acquiring the medical video may be determined on the basis of the calculated imaging duration. For example, when the calculated imaging duration is 10 seconds, a countdown for acquiring a medical video such as “Just hold still for 10 seconds and the capturing will be over. 10, 9, 8, . . . ” may be generated. Since an imaging duration of a medical video varies depending on the imaging mode, voice content generated according to the imaging mode may vary.

In an embodiment, content may include an explanation of acquiring a medical video mimicking the first user's voice. Herein, the explanation of acquiring a medical video may include an explanation of at least one selected from the group of the type of the imaging mode, a posture of a subject according to the imaging mode, and a medical imaging purpose. For example, when the imaging mode is the oral imaging mode for the second user, the content may include an explanation of oral imaging mimicking the first user's voice. As another example, when the imaging mode is the facial imaging mode for the second user, the content may include an explanation of facial imaging mimicking the first user's voice. When the content is video content mimicking the first user's face, the content may include an explanation of an imaging posture using the first user's face.

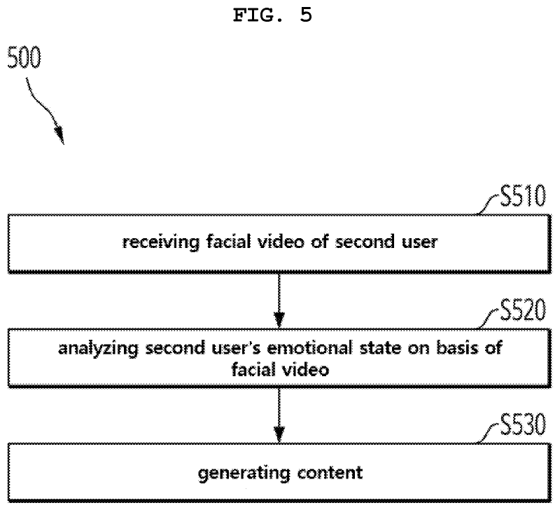

FIG. 5 is a diagram illustrating an example of a method 500 of generating voice content according to an embodiment of the present disclosure. In an embodiment, the method 500 of generating voice content may be performed by at least one processor (334 in FIG. 3, for example). The method 500 of generating voice content may be initiated by the processor receiving the voice sample or the video sample of the first user or both. In addition, the processor may receive a facial video of the second user in step S510. Herein, the first user may be a guardian of the second user, who is a subject of medical imaging. Such a facial video may be received in real time from a camera provided in the medical device for capturing the second user. That is, the medical device may include a first imaging device for acquiring a medical video of the second user, and a second imaging device (or a camera) for capturing the second user's face.

Afterward, the processor may analyze the second user's emotional state on the basis of the facial video in step S520. Specifically, the processor may detect the second user's facial area from the facial video, and may extract facial landmarks, such as eyes, nose, and mouth. In addition, the processor may extract the second user's facial expression characteristic on the basis of the facial area and the facial landmarks. Afterward, the processor may use a first machine learning model to generate the second user's emotional state on the basis of the facial expression characteristic. Herein, the first machine learning model may be trained to receive the second user's facial expression characteristic as input and to analyze and output the second user's emotional state.

Afterward, the processor may generate voice content or video content or both on the basis of the analyzed emotional state in step S530. Herein, content may include an explanation of acquiring a medical video or an everyday conversation or both mimicking the first user's voice. In addition, tones of the first user's voice and the first user's way of speaking in the content may be determined on the basis of the analyzed emotional state. For example, when the second user's emotional state corresponds to a negative emotional state, such as “extreme tension,” the voice content may include the first user's tones that reassure the second user, such as “It's okay. It will be over soon.” When the content is video content mimicking the first user's face, the content may include a video mimicking the first user's facial expression that reassures the second user.

In an embodiment, the processor may generate voice content or video content or both by using a second machine learning model. Herein, the second machine learning model may be trained to receive the second user's emotional state and the first user's voice sample or video sample or both as input, and to generate and output voice content mimicking the first user's voice and corresponding to the second user's emotional state, or video content mimicking the first user's face and corresponding to the second user's emotional state, or both. Although the first machine learning model and the second machine learning model have been described separately, the present disclosure is not limited thereto. The first machine learning model and the second machine learning model may be included in a single machine learning model. In addition, the video content may include the voice content.

With this configuration, an emotional state of a subject is analyzed on the basis of a facial video of the subject, thereby generating voice content appropriate for a situation. Accordingly, the physical and mental state of the subject may be stabilized.

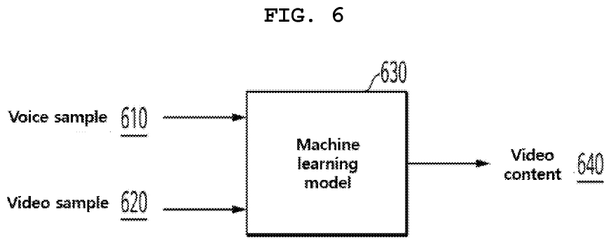

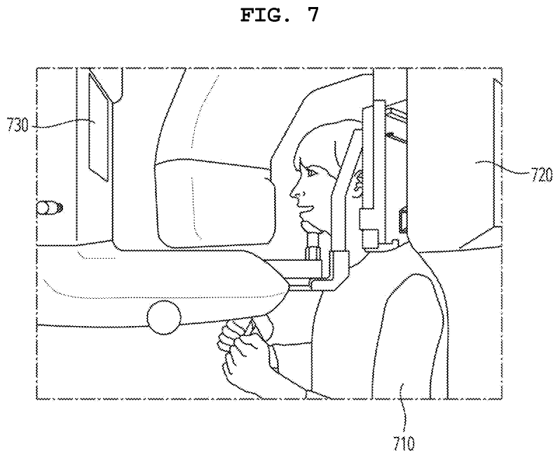

FIG. 6 is a diagram illustrating an example of a method of generating video content 640 according to an embodiment of the present disclosure. FIG. 7 is a diagram illustrating an example in which video content 640 is output on a display 730 according to an embodiment of the present disclosure. In an embodiment, a processor (334 in FIG. 3, for example) may receive the first user's voice sample 610 and video sample 620. Herein, the voice sample 610 may include at least one selected from the group of a sentence including various consonants and vowels spoken by the first user, a sentence including various intonations and tones, and a medical imaging guidance announcement. In addition, the video sample 620 may include an image of the first user's facial area. The first user may be a guardian of the second user, who is a subject of medical imaging.

In an embodiment, the processor may use a machine learning model 630 to generate the video content 640 mimicking the first user's face and voice on the basis of the voice sample 610 and the video sample 620. Herein, the machine learning model 630 may be trained to receive the voice sample 610 and the video sample 620 as input and to output the video content 640 that reflects the first user's vocal characteristic and facial characteristic. Such video content 640 may be generated in real time.

In an embodiment, the machine learning model 630 may generate the video content 640 on the basis of a voice sample and a video sample of an animated character that the second user prefers. Herein, the video content 640 may include a video mimicking the animated character's appearance and voice. In this case, the machine learning model 630 may be trained to receive the voice sample and the video sample of the animated character as input and to output the video content 640 that reflects the animated character's appearance characteristic and vocal characteristic.

In an embodiment, the processor may output the video content 640 during medical imaging. Referring to FIG. 7, the processor may transmit the video content 640 to a medical device 720 used in medical imaging. In this case, the video content 640 may be output on the display 730 of the medical device 720 during medical imaging. In addition, the voice in the video content 640 may be output through a speaker of the medical device 720. Additionally, the display 730 may be positioned in front of a second user 710 who is being captured such that the second user 710 does not move during medical imaging. Accordingly, the second user's 710 imaging posture may be maintained by fixing the gaze of the second user 710 on the display 730.

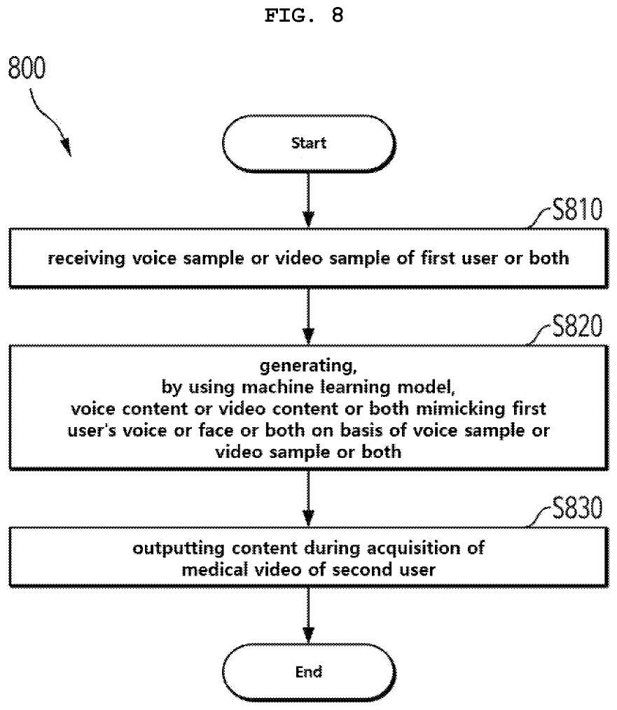

FIG. 8 is a flowchart illustrating an example of a method 800 of generating voice content according to an embodiment of the present disclosure. In an embodiment, the method 800 of generating voice content may be performed by at least one processor (334 in FIG. 3, for example). The method 800 of generating voice content may be initiated by the processor receiving a voice sample or a video sample of the first user or both in step S810. Herein, the first user may be a guardian of the second user, who is a subject of medical imaging.

Afterward, the processor use a machine learning model to generate voice content or video content or both mimicking the first user's voice or face or both on the basis of a voice sample or a video sample or both in step S820. Herein, the machine learning model may be trained to receive a voice sample or a video sample or both as input and to output voice content or video content or both reflecting the first user's vocal characteristic or facial characteristic or both. In addition, the content may include at least one selected from the group of a countdown for acquiring a medical video, an explanation of acquiring a medical video, an everyday conversation, and a song. Afterward, the processor may output content during acquisition of the medical video of the second user in step S830.

In an embodiment, the processor may receive an imaging mode of the medical video. In this case, the processor may generate voice content or video content or both on the basis of the imaging mode. Specifically, the processor may calculate an imaging duration of the medical video on the basis of the imaging mode. In addition, the processor may generate voice content or video content or both on the basis of the imaging duration and the voice sample.

In an embodiment, the processor may receive a facial video of the second user captured during medical imaging. In this case, the processor may analyze the second user's emotional state on the basis of the facial video. In addition, the processor may generate voice content or video content or both on the basis of the analyzed emotional state and the voice sample.

The above-described method may be provided as a computer program stored in a computer-readable recording medium for execution on a computer. The medium may continuously store a program executable by a computer, or may be temporarily store the program for execution or download. In addition, the medium may be various recording means or storage means in the form of a single piece of hardware or a combination of several pieces of hardware. The medium is not limited to a medium directly connected to a particular computer system, but may also be those distributed over a network. Examples of the medium include magnetic media such as a hard disk, a floppy disk, and a magnetic tape; optical recording media such as a CD-ROM and a DVD; a magneto-optical medium such as a floptical disk; and those configured to store program instructions, including a ROM, a RAM, and a flash memory. In addition, examples of other media may include recording media or storage media managed by an app store that distributes applications, or a site that supplies or distributes various other pieces of software, or a server.

The methods, operations, or techniques in the present disclosure may be implemented by various means. For example, these techniques may be implemented in hardware, firmware, software, or a combination thereof. Those skilled in the art will understand that various exemplary logical blocks, modules, circuits, and algorithm steps described in association with the disclosure herein may be implemented as electronic hardware, computer software, or combinations of both. To clearly describe the interchangeability of hardware and software, various exemplary elements, blocks, modules, circuits, and steps have been described above generally in terms of their functionality. Whether such a function is implemented as hardware or software depends upon design requirements imposed on a particular application and the overall system. Those skilled in the art may implement the described function in varying ways for each particular application, but such implementation should not be interpreted as causing a departure from the scope of the present disclosure.

In a hardware implementation, processing units used to perform the techniques may be implemented within one or more ASICs, DSPs, GPUs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, the various exemplary logical blocks, modules, and circuits described in association with the present disclosure may be implemented or performed with a general-purpose processor, a DSP, an ASIC, an FPGA, other programmable logic devices, discrete gate or transistor logic, discrete hardware components, or any combination of those designed to perform the functions described herein. A general-purpose processor may be a microprocessor, but in the alternative, the processor may be any processor, controller, microcontroller, or state machine. The processor may also be implemented as a combination of computing devices, for example, a combination of a DSP and a microprocessor, a combination of a plurality of microprocessors, a combination of one or more microprocessors in association with a DSP core, or any other combination of such configurations.

In firmware and/or software implementations, the techniques may be implemented as instructions stored on a computer-readable medium, such as a random-access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a compact disc (CD), or a magnetic or optical data storage device. The instructions may be executable by one or more processors, or may cause the processor(s) to perform particular aspects of a function described in the present disclosure.

When implemented in software, the techniques may be stored on a computer-readable medium as one or more instructions or codes, or may be transmitted through a computer-readable medium. The computer-readable media include both computer storage media and communication media, including any medium that facilitates transmission of a computer program from one place to another. The storage media may also be any available media that may be accessed by a computer. By way of non-limiting example, such computer-readable media may include RAM, ROM, EEPROM, CD-ROM or other optical disk storage, magnetic disk storage or other magnetic storage devices, or any other media that may be used to transfer or store desired program code in the form of instructions or data structures and may be accessed by a computer. In addition, any connection is properly performed via a computer-readable medium.

For example, if software is transmitted from a website, a server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks. Herein, the disks usually magnetically reproduce data, while the discs optically reproduce data using a laser. The combinations described above should also be included within the scope of the computer-readable media.

A software module may reside in a RAM memory, a flash memory, a ROM memory, an EPROM memory, an EEPROM memory, registers, a hard disk, a removable disk, a CD-ROM, or any other form of storage medium known in the art. An exemplary storage medium may be coupled to the processor such that the processor may read information from the storage medium or record information on the storage medium. Alternatively, the storage medium may be integrated into the processor. The processor and the storage medium may exist within an ASIC. The ASIC may exist in a user terminal. Alternatively, the processor and the storage medium may exist as separate elements in the user terminal.

Although preferred embodiments of the present disclosure have been described for illustrative purposes, those skilled in the art will appreciate that various modifications, additions and substitutions are possible, without departing from the scope and spirit of the disclosure as disclosed in the accompanying claims.

1. A method of generating content to facilitate medical imaging, the method being performed by at least one processor and comprising:
receiving a voice sample or a video sample of a first user or both;
generating, by using a machine learning model, voice content or video content or both mimicking the first user's voice or face or both on the basis of the voice sample or the video sample or both; and
outputting the content during acquisition of a medical video of a second user.

2. The method of claim 1, wherein the content includes at least one selected from a group of a countdown for acquiring the medical video, an explanation of acquiring the medical video, an everyday conversation, and a song.

3. The method of claim 1, wherein the machine learning model is trained to receive the voice sample or the video sample or both as input and to output the voice content or the video content or both reflecting the first user's vocal characteristic or facial characteristic or both.

4. The method of claim 1, further comprising:
receiving an imaging mode of the medical video,
wherein the generating of the voice content or the video content or both comprises:
generating the voice content or the video content or both on the basis of the imaging mode.

5. The method of claim 4, wherein the generating of the voice content or the video content or both comprises:
calculating an imaging duration of the medical video on the basis of the imaging mode; and
generating the voice content or the video content or both on the basis of the imaging duration.

6. The method of claim 1, further comprising:
receiving a facial video of the second user captured during acquisition of the medical video,
wherein the generating of the voice content or the video content or both comprises:
analyzing an emotional state of the second user on the basis of the facial video; and
generating the voice content or the video content or both on the basis of the analyzed emotional state.

7. A non-transitory computer-readable recording medium storing a computer program that, when executed by a computer, causes the computer to perform the method according to claim 1.

8. A device for generating content to facilitate medical imaging, the device comprising:
a communication module;
a memory; and
at least one processor connected to the memory, and configured to execute at least one computer-readable program included in the memory,
wherein the at least one program includes instructions for:
receiving a voice sample or a video sample of a first user or both;
generating, by using a machine learning model, voice content or video content or both mimicking the first user's voice or face or both on the basis of the voice sample or the video sample or both; and
outputting the voice content or the video content or both during acquisition of a medical video of a second user.
